(19) United States
(12) Patent Application Publication
(10) Pub. No.: US 2024/0362722 A1
(43) Pub. Date: Oct. 31, 2024

(54) METHODS, SYSTEMS, AND STORAGE MEDIUMS FOR GENERATING VOUCHERS

(71) Applicant: FORTUNE&FUTURE SHANGHAI LIMITED, Shanghai (CN)

(72) Inventor: Tiancheng HUANG, Shanghai (CN)

(73) Assignee: FORTUNE&FUTURE SHANGHAI LIMITED, Shanghai (CN)

(21) Appl. No.: 18/477,533

(22) Filed: Sep. 28, 2023

(30) Foreign Application Priority Data
Apr. 28, 2023 (CN) 202310486699.6
Apr. 28, 2023 (CN) 202310486706.2

(51) Int. Cl. G06Q 40/12; G06V 30/18; G06V 30/416

(52) U.S. Cl. CPC G06Q 40/12; G06V 30/18143; G06V 30/416

(57) ABSTRACT

Embodiments of the present disclosure provide a method, system and storage medium for generating a voucher. The method comprises: obtaining an original voucher; extracting key information of the original voucher; dividing the original voucher into at least one original voucher set based on the key information, the original voucher set including at least one original voucher of a first voucher type; and generating at least one target bookkeeping voucher corresponding to the at least one original voucher set.

### CROSS-REFERENCE TO RELATED APPLICATIONS

This application claims priority of Chinese Application No. 202310486706.2, filed on Apr. 28, 2023, and Chinese Application No. 202310486699.6, filed on Apr. 28, 2023, the entire contents of each of which are incorporated herein by reference.

### TECHNICAL FIELD

The present disclosure relates to the technical field of bookkeeping vouchers, and in particular, to a method, system, and storage medium for generating a voucher.

### BACKGROUND

Accounting vouchers are mainly used to record economic operations and clarify economic responsibility as written proof of the basis of bookkeeping. Accounting vouchers consist of original vouchers and bookkeeping vouchers. Bookkeeping vouchers are used to determine the accounting entries and serve as the basis for registering the books of accounting vouchers based on the review of the original vouchers or summary of the original vouchers, according to the content of the economic business to be categorized. In a traditional manner, an accountant manually fills out an accounting voucher based on an original document. When the accountant wants to aggregate the voucher, the accountant needs to determine a correlation manually. When a count of vouchers is large and a count of business documents fluctuates from month to month, the cost and difficulty of manual determination are high and problems such as bookkeeping errors caused by human beings occurs. In the prior art, an enterprise can parse the original voucher and then fill out a bookkeeping voucher through a series of rules configured by a digital intelligence system. However, the original voucher will be missing due to various factors such as unrecovered invoices, returned payments, and so on; and problems such as recognition errors and auto-generation rule errors result in a large deviation between the original voucher and a final bookkeeping voucher.

Accordingly, it is desirable to provide a method, system, and storage medium for generating a voucher, which is capable of generating the bookkeeping voucher by processing a large number of original vouchers by the system, henceforth effectively improving a match between the original voucher and the bookkeeping voucher.

### SUMMARY

The objective of the present disclosure is to provide a method, system, and storage medium for generating a voucher. By extracting key information of an original voucher and generating a bookkeeping voucher corresponding to the original voucher by processing the key information of the original voucher, the bookkeeping voucher of account information can be more accurately obtained, and problems such as missing or incorrect records of the original voucher can be solved according to the final bookkeeping voucher, thereby realizing a self-correcting function for the original voucher of the account information.

One or more embodiments of the present disclosure provide a method for generating a voucher. The method may comprise: obtaining an original voucher; extracting key information of the original voucher; dividing the original voucher into at least one original voucher set based on the key information, the original voucher set including at least one original voucher of a first voucher type; and generating at least one target bookkeeping voucher corresponding to the at least one original voucher set.

One or more embodiments of the present disclosure provide a system for generating a voucher. The system may comprise at least one processor and at least one storage device. The at least one storage device may be configured to store computer instructions. The at least one processor may be configured to execute at least some of the computer instructions to realize operations including: obtaining an original voucher; extracting key information of the original voucher; dividing the original voucher into at least one original voucher set based on the key information, the original voucher set including at least one original voucher of a first voucher type; and generating at least one target bookkeeping voucher corresponding to the at least one original voucher set.

One or more embodiments of the present disclosure provide a non-transitory computer-readable storage medium, comprising computer instructions that, when read by a computer, may direct the computer to implement the method for generating the voucher.

### BRIEF DESCRIPTION OF THE DRAWINGS

The present disclosure will be further illustrated by way of exemplary embodiments, which will be described in detail by means of the accompanying drawings. These embodiments are not limiting. In these embodiments, the same numbering denotes the same structure, wherein:

FIG. 1 is a schematic diagram illustrating an exemplary application scenario of a system for generating a voucher according to some embodiments of the present disclosure;

FIG. 2 is a module diagram illustrating an exemplary system for generating a voucher according to some embodiments of the present disclosure;

FIG. 3 is a flowchart illustrating an exemplary method for generating a voucher according to some embodiments of the present disclosure;

FIG. 4 is a flowchart illustrating an exemplary division of an original voucher set according to some embodiments of the present disclosure;

FIG. 5 is a schematic diagram illustrating exemplary different counts of clustering center coordinates according to some embodiments of the present disclosure;

FIG. 6 is a schematic diagram illustrating an exemplary cohesion prediction model according to some embodiments of the present disclosure;

FIG. 7 is a flowchart illustrating an exemplary process for determining a target bookkeeping voucher according to some embodiments of the present disclosure;

FIG. 8 is a schematic diagram illustrating exemplary hardware and/or software of an exemplary mobile device according to some embodiments of the present disclosure; and

FIG. 9 is a schematic diagram illustrating exemplary hardware and/or software of an exemplary computing device according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Apparently, the accompanying drawings in the following description are only some examples or embodiments of the present disclosure, and those skilled in the art can also apply the present disclosure to other similar scenarios according to the drawings without creative efforts. Unless obviously obtained from the context or the context illustrates otherwise, the same numeral in the drawings refers to the same structure or operation.

It should be understood that the terms “system”, “device”, “unit,” and/or “module” as used herein is a way to distinguish between different components, elements, parts, sections, or assemblies at different levels. However, the words may be replaced by other expressions if other words accomplish the same purpose.

As shown in the present disclosure and the claims, unless the context clearly suggests an exception, the words “a”, “an”, “one”, “one kind”, and/or “the” do not refer specifically to the singular form, but may also include the plural. Generally, the terms “including” and “comprising” suggest only the inclusion of clearly identified steps and elements, but the steps and elements do not constitute an exclusive list, and the method or device may also include other steps or elements.

Flowcharts are used in the present disclosure to illustrate operations performed by the system in accordance with embodiments of the present disclosure. It should be understood that the preceding or following operations are not necessarily performed in an exact sequence. Instead, steps may be processed in reverse order or simultaneously. Also, it is possible to add other operations to these processes or to remove a step or steps from these processes.

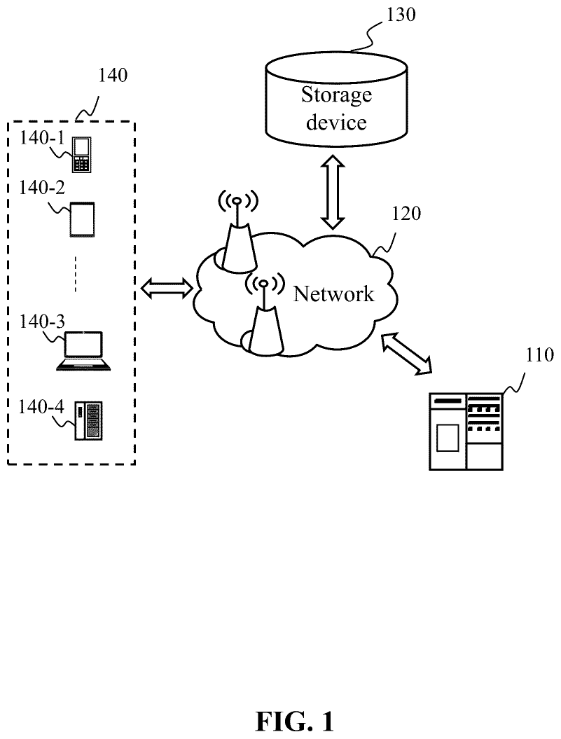

FIG. 1 is a schematic diagram illustrating an exemplary application scenario of a system for generating a voucher according to some embodiments of the present disclosure.

In some embodiments, an application scenario 100 of the system for generating the voucher may include a server 110, a network 120, a storage device 130, and a user terminal 140. The server 110 may communicate with the storage device 130 and the user terminal 140 via the network 120 to provide various functions of an online service. The storage device 130 may store all information of an online service process. In some embodiments, the user terminal 140 may send an original voucher to the server 110 and receive feedback information from the server 110. The server 110 may obtain the original voucher for processing and send a target bookkeeping voucher to the user terminal 140. The above information transmission relationship between the devices is only an example, and the present disclosure is not limited thereto.

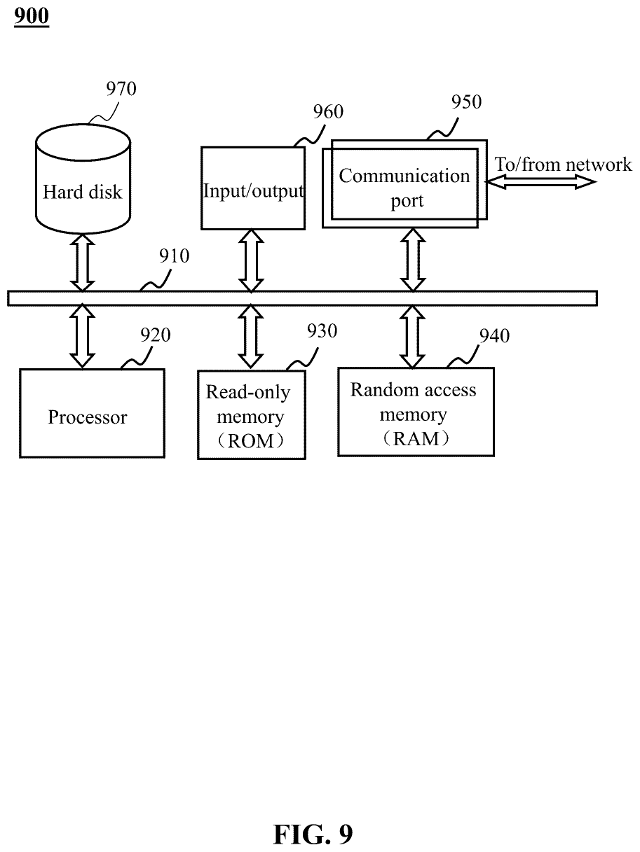

The server 110 may be configured to manage resources and process data and/or information from at least one of components of the system or an external data source (e.g., a cloud data center). In some embodiments, the server 110 may be a single server or group of servers. The group of servers may be centralized or distributed (e.g., the server 110 may be a distributed system), and may be dedicated or may be served by other devices or systems simultaneously. In some embodiments, the server 110 may be regional or remote. In some embodiments, the server 110 may be implemented on a cloud platform or provided virtually. In some embodiments, the server 110 may be implemented on a computing device 900 in FIG. 9 of the present disclosure that includes one or more components.

The network 120 may connect the components of the system and/or connect the system to the external resource. The network 120 may enable communication between the components inside the system, and with other parts outside of the system, facilitating data and/or information exchange. In some embodiments, the network 120 may be any one or more of a wired network or a wireless network. For example, the network 120 may include a cable network, a fiber optic network, a telecommunications network, the Internet, a local area network (LAN), a wide area network (WAN), a wireless local area network (WLAN), a metropolitan area network (MAN), a public switched telephone network (PSTN), a Bluetooth network, a ZigBee network (ZigBee), a near field communication (NFC), an in-device bus, an in-device line, a cable connection, or the like, or any combination thereof. A network connection between various parts may be made in one of the above ways or in multiple ways. In some embodiments, the network may be various topologies, such as a point-to-point topology, a shared topology, a centralized topology, or a combination of topologies. In some embodiments, the network 120 may include one or more network access points. For example, the network 120 may include wired or wireless network access points, such as a base station and/or a network switching point. One or more components of a system 200 for generating a voucher may be connected to the network 120 to perform data and/or information exchange through the points.

The storage device 130 may be configured to store data and/or instructions. In some embodiments, the storage device 130 may store data obtained from one or more user terminals. For example, the storage device 130 may store the original voucher from the user terminal 140. In some embodiments, the storage device may be configured to store computer instructions. The storage device 130 may include one or more storage components. Each of the one or more storage components may be a stand-alone device or may be a part of another device. For example, the storage device 130 may be a part of the server 110. In some embodiments, the storage device 130 may include a random access memory (RAM), a read-only memory (ROM), a mass storage, a removable memory, a volatile read/write memory, or the like, or any combination thereof. In some embodiments, the storage device 130 may be implemented on the cloud platform.

The user terminal 140 refers to one or more terminal devices or software used by a user. In some embodiments, the user terminal 140 may be used by one or more users, including a user who is directly using the service, or other related users. In some embodiments, the user terminal 140 may be one of a mobile device 140-1, a tablet computer 140-2, a laptop computer 140-3, a desktop computer 140-4, or other devices with input and/or output functions, or any combination thereof.

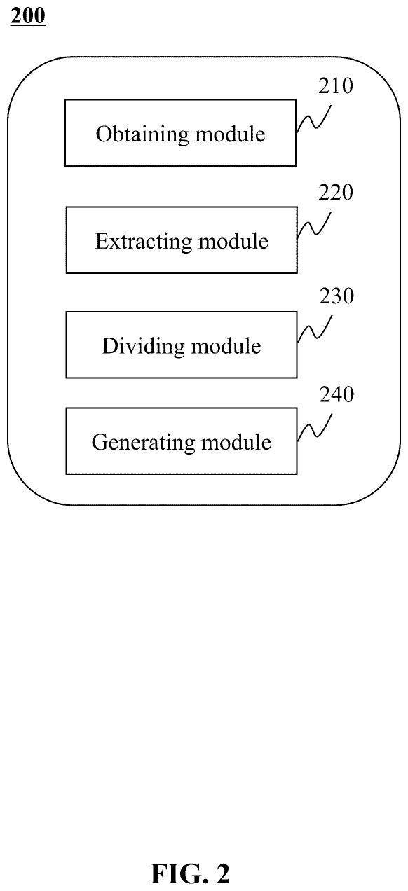

FIG. 2 is a module diagram illustrating an exemplary system 200 for generating a voucher according to some embodiments of the present disclosure.

In some embodiments, the system 200 for generating the voucher may include an obtaining module 210, an extracting module 220, a dividing module 230, and a generating module 240.

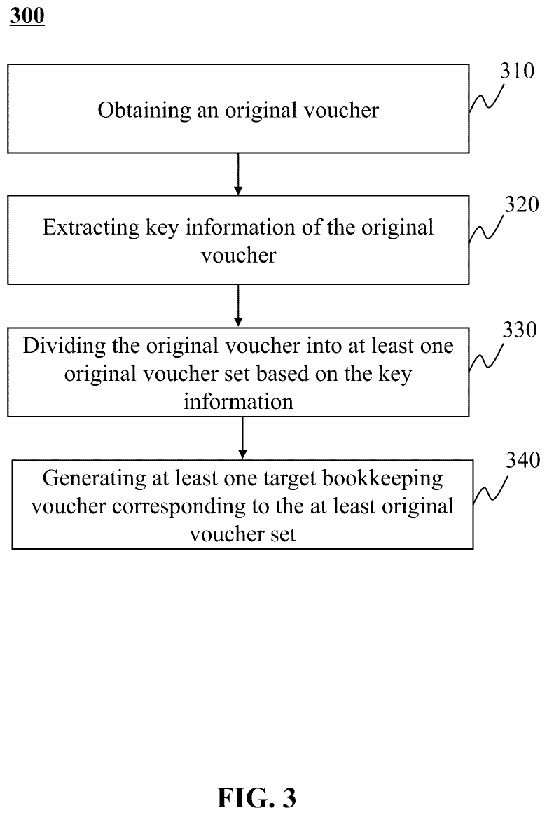

The obtaining module 210 may be configured to obtain an original voucher. Descriptions regarding the original voucher may be found in FIG. 3 and related descriptions thereof.

The extracting module 220 may be configured to extract key information of the original voucher.

In some embodiments, the extracting module 220 may be configured to determine the key information by processing the original voucher based on a preset recognition algorithm. In some embodiments, the preset recognition algorithm may include at least one of optical character recognition (OCR), regular parsing, or field mapping.

More descriptions regarding the original voucher, the key information, and the preset recognition algorithm may be found in FIG. 3 and related descriptions thereof.

The dividing module 230 may be configured to divide the original voucher into at least one original voucher set based on the key information. The original voucher set may include at least one original voucher of a first voucher type.

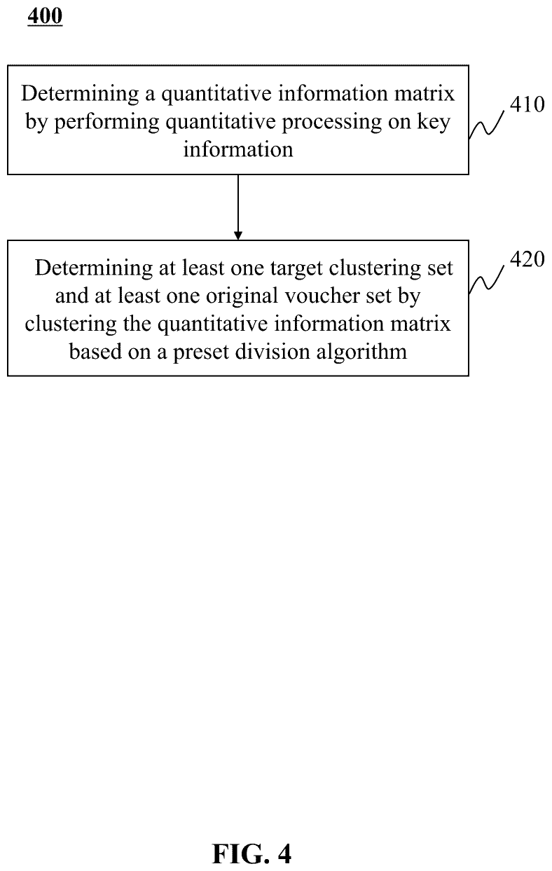

In some embodiments, the dividing module 230 may determine a quantitative information matrix by performing a quantitative processing on the key information; and determine at least one target clustering set by clustering the quantitative information matrix based on a preset division algorithm, and determine the at least one original voucher set. More descriptions regarding dividing the original voucher set may be found in FIGS. 3-4 and related descriptions thereof.

The generating module 240 may be configured to generate at least one target bookkeeping voucher corresponding to the at least one original voucher set.

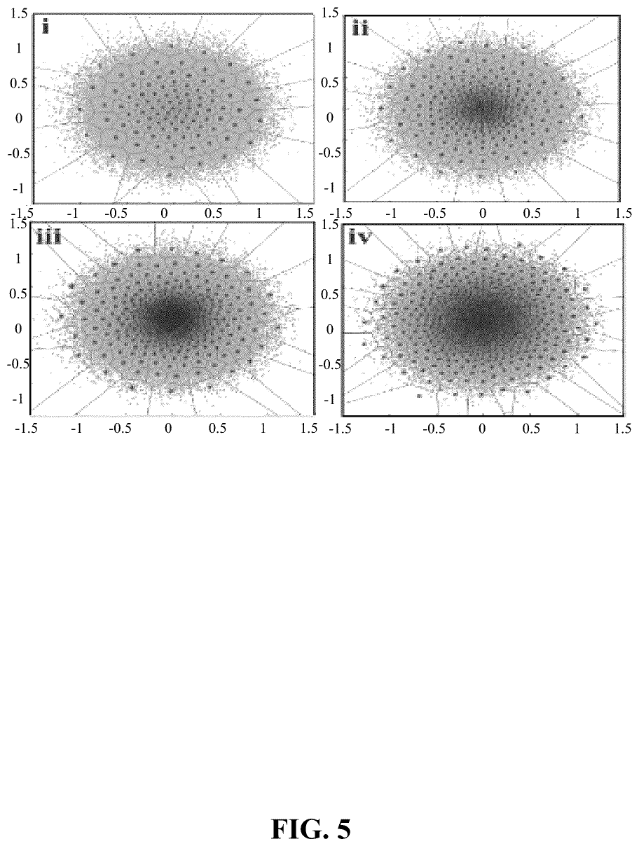

In some embodiments, the generating module 230 may be configured to generate at least one temporary bookkeeping voucher corresponding to the original voucher set for one of the at least one original voucher set based on the key information, the temporary bookkeeping voucher including at least one temporary sub-bookkeeping voucher of a second voucher type; determine a first accuracy degree corresponding to the temporary sub-bookkeeping voucher based on the key information and at least one entry information corresponding to the temporary sub-bookkeeping voucher; determine a second accuracy degree corresponding to the temporary sub-bookkeeping voucher based on the first accuracy degree corresponding to the at least one temporary sub-bookkeeping voucher; and determine the target bookkeeping voucher based on the second accuracy degree corresponding to the at least one temporary sub-bookkeeping voucher. More descriptions regarding the embodiment may be found in FIG. 5 and related descriptions thereof.

It should be noted that the above description of the system for generating the voucher and modules thereof is provided only for descriptive convenience, and does not limit the present disclosure to the scope of the cited embodiments. It is can be understood that for those skilled in the art, with an understanding of the principle of the system, it may be possible to arbitrarily combine individual modules or form subsystems to be connected to other modules without departing from this principle. In some embodiments, the obtaining module 210, the extracting module 220, the dividing module 230, and the generating module 240 disclosed in FIG. 2 may be different modules in a single system, or a single module to realize the functions of two or more of the modules. For example, the modules may share a common storage module, and the modules may include a storage module, respectively. Such variations are within the scope of protection of the present disclosure.

FIG. 3 is a flowchart illustrating an exemplary method for generating a voucher according to some embodiments of the present disclosure. In some embodiments, a process 300 may be performed by a processor or the system 200 for generating the voucher. For example, the process 300 may be stored in the storage device 130 in the form of a program or an instruction, and the process 300 may be implemented when the processor or the system 200 for generating the voucher executes the instruction. The flowchart of operations of the process 300 presented below is illustrative. In some embodiments, the process may be completed by one or more additional operations not described and/or one or more operations not discussed. In addition, the order of operations of the process 300 illustrated in FIG. 3 and described below is not limiting. As shown in FIG. 3, the process 300 may include following operations.

In 310, an original voucher may be obtained.

The original voucher, also known as a document, may be a written document used to record or prove sending or completion of an economic operation. A voucher type (hereinafter referred to as a first voucher type) of the original voucher may include, but is not limited to, a business document (e.g., a shipment invoice, a delivery receipt, a material requisition, various reimbursement documents, etc.), a single invoice, a bank statement, etc.

In some embodiments, a user may upload the at least one original voucher to a server to generate an electronic version or a scanned version of the original voucher by typing, scanning, and photographing the original voucher, and store the electronic version or the scanned version of the original voucher in a storage device.

In some embodiments, the processor may read the electronic version or the scanned version of the original voucher from the storage device. The storage device may be the storage device 130 of the system for generating the voucher, or an external storage device that is not part of the system for generating the voucher, such as a hard disk, a CD-ROM, or the like. In some embodiments, the processor may read the original voucher via an interface. The interface may include, but is not limited to, a program interface, a data interface, a transmission interface, or the like. In some embodiments, the system for generating the voucher may automatically extract the original voucher from the interface when the system for generating the voucher works. In some embodiments, the system for generating the voucher may be called by other external devices or systems, and the original voucher may be passed to the system for generating the voucher when the system for generating the voucher is called. In some embodiments, the original voucher may also be obtained in any manner known to those skilled in the art, which is not limited in the present disclosure.

In some embodiments, the processor may obtain a certain count of original vouchers. This count is referred to as a second preset count. The second preset count is not limited in the embodiments of the present disclosure. The second preset count may be a count of original vouchers received over a period of time.

In some embodiments, the processor may obtain at least one original voucher of one or more first voucher types from the storage device. The first voucher types of the obtained original voucher are not limited in the embodiments of the present disclosure.

In 320, key information of the original voucher may be extracted.

The key information refers to important content included in the original voucher. In some embodiments, the key information may include one or more pieces of item information.

In some embodiments, the item information may include basic content of the original voucher. In some embodiments, the item information may include basic content of the original voucher and filling content corresponding to the basic content. For example, a “voucher name” in the original voucher is the basic content, and an “xx company” filled in the “voucher name” is the filling content corresponding to the basic content.

In some embodiments, the key information of the original voucher of different first voucher types may be different. For example, the key information of the original voucher of the different first voucher types may be different in terms of the item information (e.g., the basic content, etc.) contained therein, and/or may be different in terms of a count of pieces of item information contained therein. Exemplarily, when the original voucher is an electronic invoice, key information in the electronic invoice may include an item name, a seller name, and an amount. Exemplarily, when the original voucher is a business document, key information in the business document may include a payment/reimbursement instruction, a payee, and an amount.

In some embodiments, the key information may be extracted from the original voucher in various feasible ways, such as by manual recognition or computer recognition. For example, the key information may be extracted from the original voucher by computer software.

In some embodiments, the processor may determine the key information by processing the at least one original voucher based on a preset recognition algorithm.

The preset recognition algorithm refers to an algorithm that is set up in advance to be used for extracting the key information from the original voucher. The preset recognition algorithm may take a plurality of forms.

In some embodiments, the preset recognition algorithm may include at least one of optical character recognition (OCR), regular parsing, or field mapping.

In some embodiments, the preset recognition algorithm may also include a Faster Region-based Convolutional Neural Network (RCNN) in machine learning image recognition, Single Shot Detectors (SSD), You Ony Look Once (YOLO), or the like. The embodiments of the present disclosure do not have any special limitation on the way of extracting the key information, and it is sufficient to adopt an operation known to those skilled in the art.

In some embodiments of the present disclosure, extracting the key information from the original voucher through the preset recognition algorithm can effectively reduce an error rate of manual extraction, shorten a length of the manual extraction, and improve the efficiency and accuracy of information extraction.

In 330, the original voucher may be divided into at least one original voucher set based on the key information.

In some embodiments, the original voucher set may include at least one original voucher belonging to a same first voucher type.

The processor may divide the original voucher into the at least one original voucher set in various ways. In some embodiments, the processor may divide at least one original voucher having same key information into an original voucher set. In some embodiments, the processor may divide the at least one original voucher belonging to the same first voucher type into an original voucher set. In some embodiments, the processor may divide at least one original voucher belonging to a same ledger into an original voucher set. Belonging to the same ledger means that the original voucher may be registered in the same ledger. For example, an original voucher related to revenue may be registered in a revenue type ledger, an original voucher related to cost may be registered in a cost type ledger, and an original voucher related to expenditure may be registered in an expenditure type ledger.

In some embodiments, the processor may divide the original voucher into a first preset count of original voucher set based on the first preset count.

In some embodiments, the processor may determine a quantitative information matrix by performing a quantitative processing on the key information; and determine at least one target clustering set by clustering the quantitative information matrix based on a preset division algorithm, and determine at least one original voucher set. A count of the at least one target clustering set may be the first preset count. More descriptions regarding this embodiment may be found in FIG. 4 and related descriptions thereof.

In 340, at least one target bookkeeping voucher corresponding to the at least original voucher set may be generated.

The target bookkeeping voucher refers to an accounting voucher obtained by division and entry of the original voucher.

In some embodiments, the target bookkeeping voucher may include at least one sub-bookkeeping voucher. For example, the target bookkeeping voucher may include one or more specialized vouchers and/or generic vouchers. Merely by way of example, the target bookkeeping voucher may include at least one of a payment voucher, a receipt voucher, a transfer voucher, a generic voucher, or the like.

In some embodiments, each original voucher set may correspondingly generate a target bookkeeping voucher. For example, a target bookkeeping voucher may be generated when a plurality of original vouchers belongs to the same first voucher type. When a plurality of original vouchers are all travel reimbursements, the plurality of original vouchers may belong to the same first voucher type. As another example, when one original voucher is a payroll and another original voucher is an expense reimbursement, the two original vouchers may not belong to the same first voucher type.

In some embodiments, the processor may convert the key information of the original voucher into entry information; generate a sub-bookkeeping voucher based on the entry information corresponding to the same original voucher; and determine at least one sub-bookkeeping voucher corresponding to an original voucher belonging to a same original voucher set as the target bookkeeping voucher.

In some embodiments, the processor may convert the key information of the original voucher into the entry information; generate an initial bookkeeping voucher by combining the entry information corresponding to a same original voucher; and obtain the target bookkeeping voucher by combining the initial bookkeeping voucher corresponding to the same original voucher set.

The entry information refers to content constituting a bookkeeping voucher. In some embodiments, the entry information may include one or more of a summary, an accounting section, an accounting item, and an entry amount. The entry amount may include a debit amount and a credit amount.

In some embodiments, the entry information may relate to a voucher type (hereinafter referred to as a second voucher type) of the bookkeeping voucher. In some embodiments, the second voucher type may include a receipt voucher, a payment voucher, a transfer voucher, a generic voucher, or the like. Entry information of bookkeeping vouchers of different second voucher types may be different. For example, entry information of the receipt voucher may include a credit account, amount, etc. Entry information of the transfer voucher may include a summary, an accounting section, an entry amount, etc.

In some embodiments, a conversion relationship between the key information and the entry information may be predetermined based on historical data or a priori knowledge. Merely by way of example, when an original voucher A is a business document, the business document may include key information such as a payment/reimbursement instruction, a payee, an amount, etc. The processor may convert the “payment/reimbursement instruction” of the key information into “accounting section” and “summary”, convert the “payee” of the key information into “accounting item”, and convert the “amount” of the key information into “entry amount”. After such conversion, a target bookkeeping voucher corresponding to the original voucher A may be obtained.

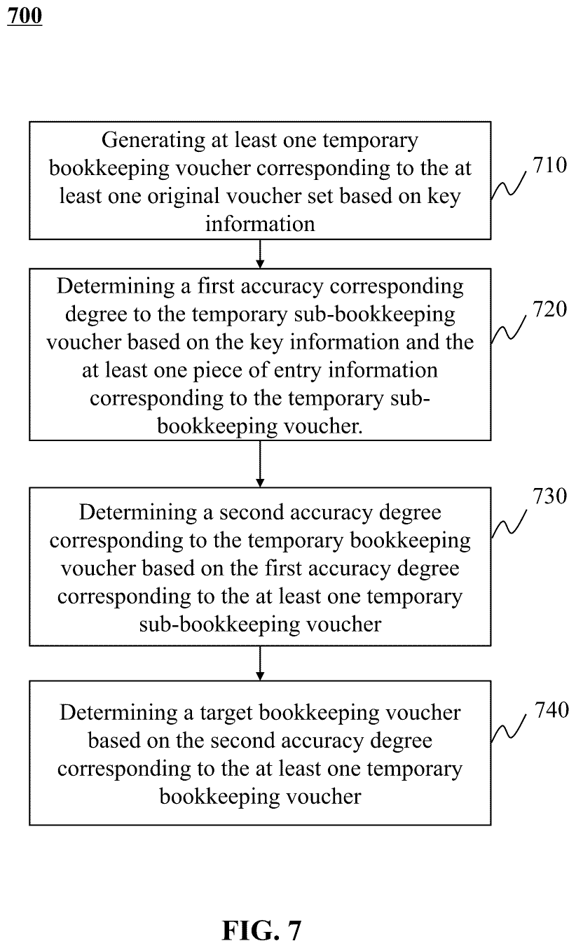

In some embodiments, the processor may convert the key information of the original voucher into the entry information based on the original voucher of the first voucher type, and the conversion relationship between the key information and the entry information. More descriptions regarding converting the key information into the entry information may be found in FIG. 7 and related descriptions thereof.

In some embodiments, the processor may generate at least one temporary bookkeeping voucher, and determine the target bookkeeping voucher from the at least one temporary bookkeeping voucher. More descriptions regarding this embodiment may be found in FIG. 7 and related descriptions thereof.

In some embodiments of the present disclosure, the key information of the original voucher may be extracted by the preset recognition algorithm, which is helpful for subsequently dividing the original voucher based on the key information, and generating the bookkeeping voucher corresponding to the original voucher based on the key information, thereby greatly improving the working efficiency and accuracy of generating the target bookkeeping voucher compared to manual operation.

FIG. 4 is a flowchart illustrating an exemplary division of an original voucher set according to some embodiments of the present disclosure.

In 410, a quantitative information matrix may be determined by performing a quantitative processing on key information.

The quantitative processing refers to quantifying data into data that may be computed by a specific algorithm. For example, the quantitative processing may quantify the key information into data that may be computed by a preset division algorithm.

The quantitative information matrix refers to a matrix consisting of a plurality of pieces of quantitative information of a plurality of original matrixes. An exemplary quantitative information matrix may be shown in a following table.

| | Key information | | | |
|---|---|---|---|---|
| | Item | Item | Item | |
| | information 1 | information 2 | information 3 | . . . |
| Original | A1 | A2 | A3 | . . . |
| vouhcer 1 | | | | |
| Original | B1 | B2 | B3 | . . . |
| voucher 2 | | | | |
| . . . | . . . | . . . | . . . | . . . |

A1, A2, A3, etc., denote quantitative information of an original voucher 1, and B1, B2, B3, etc., denote quantitative information of an original voucher 2, respectively.

In some embodiments, the quantitative information may be data obtained after quantitative processing based on filling content included in item information. More descriptions regarding the item information may be found in FIG. 3 and related descriptions thereof.

The quantitative processing may include various ways, such as an equidistance process a fuzzy clustering process, a self-organizing mapping (0SOM) neural network classification process, or the like. The embodiments of the present disclosure do not have a special limitation on the way of quantitative processing, and it is sufficient to adopt the operation known to those skilled in the art.

In some embodiments, the processor may recognize a count of pieces of item information of an original voucher based on the key information; generate quantitative information of the original voucher by performing the quantitative processing on the item information; and form the quantitative information matrix based on the count of pieces of item information and quantitative information of each of the at least one original voucher.

The key information of the original voucher may include a plurality of pieces of item information. A count of pieces of item information in the key information may vary depending on the first voucher type of the original voucher. Correspondingly, the processor may determine the first voucher type of the original voucher based on the key information; and determine the count of pieces of item information of the original voucher based on the first voucher type of the original voucher. For example, when the original voucher is an electronic invoice, the key information in the electronic invoice may include an item name, a seller name, and an amount. The item name may correspond to the summary and the accounting section of the bookkeeping voucher, the seller name may correspond to the accounting item of the bookkeeping voucher, and the amount may correspond to the debit amount and the credit amount of the bookkeeping voucher. Accordingly, the count of pieces of item information may be determined to be 3.

In some embodiments, the processor may generate an eigenvalue (i.e., digital quantification) of each piece of item information by quantifying each piece of item information included in the key information of the original voucher, thereby generating quantitative information of the original voucher. For example, the processor may digitally quantize a value for each piece of item information of the original voucher, and compose an eigenvalue corresponding to each piece of item information into the quantitative information of each original voucher. In some embodiments, the processor may obtain the quantitative information (which includes eigenvalues corresponding to a plurality of pieces of item information) of the each original voucher by quantifying the plurality of pieces of item information of the each original voucher. The quantitative information of a second preset count of original vouchers may be combined into the quantitative information matrix. More descriptions regarding the second preset count may be found in FIG. 3 and related descriptions thereof.

In some embodiments of the present disclosure, a problem that an accountant is required to artificially determine correlation when the original vouchers are aggregated and fails to determine a final count of bookkeeping vouchers may be relieved by clustering.

In 420, at least one target clustering set and at least one original voucher set may be determined by clustering the quantitative information matrix based on a preset division algorithm.

The target clustering set refers to a clustering result. In some embodiments, the target clustering set may include a plurality of pieces of quantitative information clustered together. The target clustering set may be configured to divide the original voucher. A plurality of original vouchers (i.e., the original voucher set) divided in a target clustering set may be used to generate a target bookkeeping voucher.

In some embodiments, a count of the target clustering sets may be related to a first preset count of the target bookkeeping voucher. In some embodiments, the first preset count may be a system default, an empirical value, a manual preset value, or the like, or any combination thereof, which may be set according to actual needs, and is not limited in the present disclosure. In some embodiments, the first preset count may be a suitable first preset count selected in accordance with a count of bookkeeping vouchers required by a user. For example, the first preset count required by the user may stabilize a count of vouchers per month within a fluctuating interval.

The preset division algorithm may be configured to cluster the quantitative information matrix. The preset division algorithm may be in various forms. In some embodiments, the preset division algorithm may be a Fuzzy C-Means algorithm, among others.

In some embodiments, the processor may cluster the original voucher according to the key information (or the quantitative information) through the preset division algorithm, and divide the original voucher into a first preset count of target clustering sets. Each target clustering set may be used to generate a target bookkeeping voucher.

In some embodiments, the processor may obtain the target clustering set by clustering a plurality of pieces of quantitative information whose similarity differences between the plurality of pieces of quantitative information are less than a preset difference threshold through the preset division algorithm. Correspondingly, the target clustering set may include a certain count of pieces of quantitative information with a strong correlation as a basis for filling in the target bookkeeping voucher.

In some embodiments, the preset division algorithm may include: setting a fuzzy indication value according to the quantitative information matrix and determining a first clustering matrix; and determining the at least one target clustering set by performing an iterative update on the first clustering matrix.

The fuzzy indication value refers to a fuzzy coefficient of the preset division algorithm, which may affect an accuracy degree of classification. Optionally, the fuzzy indication value is not limited in the present disclosure, which may be set to 2 or other reasonable values.

The first clustering matrix refers to a clustering result obtained through preliminary clustering based on the quantitative information matrix. In some embodiments, the first clustering matrix may include a first preset count of first eigenvalue sets. The first eigenvalue set may be a set including a plurality of eigenvalues.

In some embodiments, the processor may set the first clustering matrix by random initialization.

In some embodiments, the processor may set a first clustering center set corresponding to the first clustering matrix by the random initialization. For example, the first clustering center set corresponding to the first clustering matrix may be obtained by determining a random eigenvalue of each first eigenvalue set in the first clustering matrix as a first clustering center of the first eigenvalue set.

In some embodiments, the processor may determine the at least one target clustering set by performing the iterative update on the first clustering matrix. The target clustering set refers to a final clustering result.

In some embodiments, a process the iterative update may include following operations S1-S4.

In S1, a first affiliation matrix of the quantitative information matrix with respect to the first clustering matrix may be determined by calculating an affiliation correlation of each quantitative information with each first clustering center in the first eigenvalue set based on a first preset expression.

In some embodiments, the processor may calculate an affiliation correlation between quantitative information of each original voucher and each first clustering center in the first eigenvalue set based on the first preset expression. The original voucher may belong to a first eigenvalue set corresponding to a first clustering center with a highest affiliation correlation.

In some embodiments, the first preset expression may be expressed as formula (2):

$${u}_{ij} = \frac{1}{{\sum }_{k = 1}^{c} {( \frac{‖ {x}_{j} - {a}_{i}^{0} ‖}{‖ {x}_{j} - {a}_{k}^{0} ‖} )}^{\frac{2}{m - 1}}} . \qquad ( 2 )$$

More detailed explanation regarding formula notation may be found below.

In S2, a second clustering center set may be calculated based on a second preset expression according to the first affiliation matrix.

The second clustering center set refers to a clustering center set that is continually updated during an iteration process. In some embodiments, the second clustering center set may include a first preset count of second clustering centers. The second clustering centers refer to clustering centers of a second eigenvalue set. The second eigenvalue set is a clustering result that is constantly updated during the iteration process.

In some embodiments, the second clustering center set may be iteratively updated based on a second preset expression. In some embodiments, the second preset expression may be expressed as formula (3):

$${a}_{i}^{1} = \frac{{\sum }_{j = 1}^{n} {u}_{ij}^{m} {x}_{j}}{{\sum }_{j = 1}^{n} {u}_{ij}^{m}} . \qquad ( 3 )$$

More detailed explanation regarding formula notation may be found below.

In S3, a distance value between the second clustering center set and the first clustering center set may be calculated based on a distance expression, and in response to a determination that the distance value is less than a preset distance threshold, the iterative update may be stopped.

The distance value between the second clustering center set and the first clustering center set being less than the preset distance threshold may indicate that the second clustering center set is very close to the first clustering center set, and iterative update is not required. The preset distance threshold may be used to prevent a dead loop. Optionally, the preset distance threshold is not limited in the embodiments of the present disclosure. For example, the preset distance threshold may be 0.01, or other suitable values.

In some embodiments, the distance expression may be expressed as equation (4):

$$L = {\sum }_{i = 1}^{c} {‖ {a}_{i}^{1} - {a}_{i}^{0} ‖}^{2} . \qquad ( 4 )$$

More detailed explanation regarding formula notation may be found below.

In some embodiments, the iterative update may further include: in response to a determination that the distance value is not less than the preset distance threshold, a second clustering center set of a current iteration may be used as a first clustering center set of a next iteration, and a first affiliation matrix and a second clustering center set of the next iteration may be determined.

Merely by way of example, when the distance value between the second clustering center set and the first clustering center set is not less than the preset distance threshold, the processor may perform S1 again to calculate an affiliation correlation of each piece of quantitative information with each second clustering center in the second clustering center set based on the first preset expression, so as to obtain a second affiliation matrix (which is a first affiliation matrix of the next iteration). Further, the processor may perform S2 again to calculate a third clustering center set (which is a second clustering center set of the next iteration) based on the second affiliation matrix through the second preset expression. The iterative update may be stopped when the distance value between the third clustering center set and the second clustering center set is less than the preset distance threshold. Similarly, when the distance value between the third clustering center set and the second clustering center set is not less than the preset distance threshold, S1 and S2 may be cycled based on the third clustering center set to calculate a third affiliation matrix (which is a first affiliation matrix of the next iteration) and a fourth clustering center set (which is a second clustering center set of the next iteration) until a distance value between a calculated clustering center set and a clustering center in the previous iteration is less than the preset distance threshold, the iterative update may be stopped.

In S4: the target clustering set may be determined based on a second clustering center set of a last iteration, and at least one original voucher set may be obtained by determining an original voucher corresponding to quantitative information divided to each target clustering set based on a first affiliation matrix of a last iteration.

In some embodiments, the processor may determine a target clustering center of each accounting voucher set based on the second clustering center set of the last iteration, and obtain the at least one original voucher set by determining the original voucher corresponding to quantitative information divided to each target clustering set based on the first affiliation matrix of the last iteration.

In some embodiments, after S4, S5-S7 may be further performed.

In S5, a first evaluation value corresponding to the target clustering set may be calculated based on a third preset expression.

The first evaluation value may be used to reflect a cohesion between a plurality of original vouchers in a first preset count of target clustering sets (or original voucher sets corresponding to the target clustering sets). The higher the cohesion, the lower the first evaluation value.

In some embodiments, the third preset expression may be expressed as formula (5):

$$J ( u , a ) = {\sum }_{i = 1}^{c} {\sum }_{j = 1}^{n} {u}_{ij}^{m} {‖ {x}_{j} - {a}_{i}^{1} ‖}^{2} . \qquad ( 5 )$$

In formulas (1)-(5), i=1, 2, . . . , c, c denotes the first preset count, i denotes a label of each target bookkeeping voucher, aᵢ⁰ denotes a first clustering center set of a target bookkeeping voucher labeled with i, aᵢ¹ denotes a second clustering center set of a target bookkeeping voucher labeled with i, aₖ⁰ denotes a first clustering center set of a target bookkeeping voucher labeled with k, and a denotes the clustering center set of the target bookkeeping voucher; j=1, 2, . . . , n, n denotes the second preset count of the original vouchers, j denotes a label of each original voucher, xⱼ denotes quantitative information of an original voucher labeled with j; m denotes the fuzzy indication value, which is a constant greater than 1; uᵢⱼ denotes the affiliation correlation, which represents an affiliation of the original voucher labeled with j with a target bookkeeping voucher labeled with i; J(u, a) denotes the evaluation value; and L denotes the distance value.

In some embodiments, S5 may further include following operations. An S-th affiliation matrix and a (S+1)-th clustering matrix may be calculated based on an S-th clustering matrix when a distance value between the S-th clustering matrix and a (S−1)-th clustering matrix is not less than the preset threshold, where S is an integer greater than 1. For example, when the distance value between the S-th clustering matrix and the (S−1)-th clustering matrix is not less than the preset distance threshold, it may indicate that a cohesion among original vouchers in an accounting voucher corresponding to the S-th clustering matrix is not high, and it is also necessary to iteratively calculate a clustering matrix by cyclically performing S1-S2 until a distance value between a generated clustering matrix and a previous clustering matrix is less than the preset threshold. The S-th clustering matrix and the (S−1)-th clustering matrix refer to second clustering matrixes in two consecutive iterations.

In S6, a second evaluation value corresponding to an updated first preset count of target clustering sets may be obtained by updating the first preset count and re-clustering the quantitative information matrix based on the preset division algorithm.

In some embodiments, the processor may update the first preset count by adding or subtracting from an original first preset count. For example, the processor may update the first preset count by adding a preset value to the original first preset count. The preset value may be a system default value, or an artificial preset value, etc.

In some embodiments, the processor may also update the first preset count in other ways. More descriptions may be found in FIG. 7.

In some embodiments, the processor may determine the updated first preset count of target clustering sets by performing S1-S4 based on the updated first preset count, and determine the second evaluation value corresponding to the updated first preset count of target clustering sets by performing S5.

In S7, in response to a determination that the second evaluation value is less than the first evaluation value, the at least one target clustering set may be determined based on the second clustering center set corresponding to the updated first preset count, and the original voucher corresponding to the quantitative information divided to each target clustering set may be determined.

When the second evaluation value is less than the first evaluation value, it indicates that cohesion of the original vouchers in the updated first preset count of target clustering sets may be higher. For example, when the updated first preset count is a third preset count, the processor may obtain a third evaluation value corresponding to the third preset count of target clustering sets by performing S1-S5. When the updated first preset count is a fourth preset count, the processor may obtain a fourth evaluation value corresponding to a fourth preset count of target clustering sets by performing S1-S5. Similarly, a plurality of corresponding evaluation values may be obtained by clustering the quantitative information matrix through updating the first preset count multiple times in the embodiments of the present disclosure. By comparing the plurality of evaluation values, a clustering matrix corresponding to a smallest evaluation value may be determined as a clustering center of each eigenvalue set.

Merely by way of example, if there are j invoices, X={x1, x2 . . . xj} may be input. An algorithm loop iteration may be stopped using an algorithm-stopping parameter ¿ (i.e., the preset distance threshold), which is generally used to prevent a dead loop. A count of iterations of the algorithm is s. The algorithm may be divided into following steps.

In step 1: a random initial value a⁽⁰⁾={a₁⁽⁰⁾, a₂⁽⁰⁾, . . . , a_{C}⁽⁰⁾} representing c clustering centers is set, and s is set to be 1 first.

In Step 2: u^{(s)} is calculated through a^{(s-1)} based on the first preset expression.

In Step 3: a^{(s)} is calculated through u^{(s)} based on the second preset expression.

In Step 4: based on the distance expression, if a distance value of a^{(s)}−a^{(s-1)} is less than ε, a current a^{(s)} is output, otherwise, and the iterative calculation. Finally, c a^{(s)} and J(u, a) may be obtained as a target evaluation value of such clustering is continued by jumping to Step 2.

In Step 5: c in Step 1 is changed, where c represents how many target bookkeeping vouchers are to be generated. If an enterprise expects to generate m−n target bookkeeping vouchers per month, then a value of c may be m−n. (n−m) J(u, a) are generated by cycling (n−m) times of step 1 to step 4. The smaller the J(u, a), the higher cohesion between the original vouchers. A lowest J(u, a) may mean that such clustering manner has a highest cohesion.

FIG. 5 is a schematic diagram illustrating exemplary different counts of clustering centers according to some embodiments of the present disclosure. Referring to FIG. 5, in some embodiments, a two-dimensional feature clustering division may be shown as a schematic diagram, with fine dots in each grid representing a large count of original vouchers, and coarse dots in each grid representing a clustering center, i.e., a bookkeeping voucher. i, ii, iii, and iv may represent a division of 100, 256, 400, and 576 clustering centers, respectively. It can be understood that original vouchers within each grid belong to a same bookkeeping voucher, i.e., i, ii, iii, and iv may represent 100, 256, 400, 576 bookkeeping vouchers, respectively.

In some embodiments, the processor may generate a first preset count of target bookkeeping vouchers based on clustering centers of each target clustering set and original vouchers (i.e., an original voucher set) corresponding to quantitative information divided to the each target clustering set. In some embodiments, the processor may convert key information of the original voucher set through a preset conversion rule based on first voucher types of the at least one original voucher set, so as to generate target bookkeeping vouchers corresponding to the at least one original voucher set. More descriptions regarding the first voucher types, the key information, and the preset conversion rule may be found in FIG. 3 and FIG. 7 and related descriptions thereof.

Taking an electronic invoice as the original voucher as an example, the system for generating the voucher may first identify an item name, a seller name, and an amount of the invoice by performing OCR and other ways. Entry information may include five elements, including summary, an accounting section, an accounting item, a debit amount, and a credit amount. The summary and the accounting section of the entry information may be valued based on the item name of the invoice; the accounting item of the entry information may be valued based on the seller name of the invoice; and the debit/credit amount of the entry information may be valued based on the amount of the invoice. A bookkeeping voucher may be obtained based on the item name, the seller name, and the amount on the electronic invoice.

An original voucher x in a first preset expression may have 3-dimensional features, x={Item Name, Seller Name, Amount}. If there are j invoices, then a quantitative information matrix may be xj, where xj={x1, x2 . . . xj}.

An example of six electronic invoices may be shown in Table 2.

TABLE 2
Information table of six electronic invoices

| No. | Item name | Seller name | Amount |
|---|---|---|---|
| x₁ | Purchasing a server | Ali Cloud | 300 |
| x₂ | Purchasing bandwidth | Ali Cloud | 100 |
| x₃ | Purchasing a server | TenCent Cloud | 500 |
| x₄ | Purchasing bandwidth | TenCent Cloud | 200 |
| x₅ | Purchasing a server | Huawei Cloud | 100 |
| x₆ | Purchasing bandwidth | Huawei Cloud | 5 |

∥x∥ denotes a Euclidean distance, the smaller the Euclidean distance, the greater the similarity, and the larger the Euclidean distance, the smaller the similarity. For example, ∥x1−x5∥ may be to calculate a similarity between Invoice 1 and Invoice 5 in each dimension. For example, ∥x1−x5∥=a similarity between Purchasing a server and Purchasing a server+a similarity between Ali Cloud and Huawei Cloud+a similarity between 300 and 100. In order to better demonstrate a process and facilitate calculation, item information of each original voucher may be digitally quantified. Assuming that Purchasing a server=0 and Purchasing bandwidth=1; Ali Cloud=0.1, TenCent Cloud=0.3, Huawei Cloud=0.5; then the amount may be normalized, i.e., the amount may all be divided by a maximum amount of 500. Then, ∥x1−x5∥=√((0−0)*2+(0.1−0.5)*2+(300/500−100/500)*2)=√(0+0.16+0.16).

Digital quantification of information of the six electronic invoices may be shown in Table 3.

TABLE 3
Quantification table of six electronic invoices

| No. | Item name | Seller name | Amount |
|---|---|---|---|
| x₁ | 0 | 0.1 | 0.6 |
| x₂ | 1 | 0.1 | 0.2 |
| x₃ | 0 | 0.3 | 1 |
| x₄ | 1 | 0.3 | 0.4 |
| x₅ | 0 | 0.5 | 0.2 |
| x₆ | 1 | 0.5 | 1 |

A quantitative information matrix xj may be generated based on Table 3. 2 target bookkeeping vouchers may be assumed to be generated.

In step 1 of a preset division algorithm: c=2, a preset threshold ε=0.01, a fuzzy indication value m=2. A first clustering matrix a⁰ of an initial accounting voucher may be set, and random initial values a⁰={a₁⁰, a₂⁰}={(0.2,0.2,0.2), (0.3,0.3,0.3)} of 2 clustering centers may be randomly set.

In step 2 of the preset division algorithm: a u-value of a first affiliation matrix may be calculated. Each u-value may be calculated based on a first preset formula.

$${u}_{11} = 1 / ( {( ‖ {x}_{1} - {a}_{1} ‖ / ‖ {x}_{1} - {a}_{1} ‖ )}^{2} + {( ‖ {x}_{1} - {a}_{1} ‖ / ‖ {x}_{1} - {a}_{2} ‖ )}^{2} ) = 1 / ( 1 + ( {0.2}^{2} + 0 . {1}^{2} + 0 . {4}^{2} ) / ( 0 . {3}^{2} + 0 . {2}^{2} + 0 . {3}^{2} ) ) \approx 0.51$$

$${u}_{21} = 1 / ( {( ‖ {x}_{1} - {a}_{2} ‖ / ‖ {x}_{1} - {a}_{1} ‖ )}^{2} + {( ‖ {x}_{1} - {a}_{2} ‖ / ‖ {x}_{1} - {a}_{2} ‖ )}^{2} ) \approx 0.48$$

Since u₁₁>u₁₂, x₁ may belong to a₁.

$${u}_{12} = 1 / ( {( ‖ {x}_{2} - {a}_{1} ‖ / ‖ {x}_{2} - {a}_{1} ‖ )}^{2} + {( ‖ {x}_{2} - {a}_{1} ‖ / ‖ {x}_{2} - {a}_{2} ‖ )}^{2} ) \approx 0.45$$

$${u}_{22} = 1 / ( {( ‖ {x}_{2} - {a}_{2} ‖ / ‖ {x}_{2} - {a}_{1} ‖ )}^{2} + {( ‖ {x}_{2} - {a}_{2} ‖ / ‖ {x}_{2} - {a}_{2} ‖ )}^{2} ) \approx 0.55$$

Since u₂₂>u₂₁, x₂ may belong to a₂.

Such calculation process may also be true for other u-values, which are not listed here. u₁₁, u₂₁, u₁₂, and u₂₂ . . . may form a first affiliation matrix uᵢⱼ.

In step 3 of the preset division algorithm: a second clustering center set a¹ may be calculated. A value of a¹ may be calculated based on a second expression.

$${a}_{1}^{1} = ( {u}_{11}^{2} {x}_{1} + {u}_{12}^{2} {x}_{2} + {u}_{13}^{2} {x}_{3} + {u}_{14}^{2} {x}_{4} + {u}_{15}^{2} {x}_{5} + {u}_{16}^{2} {x}_{6} ) / ( {u}_{11}^{2} + {u}_{12}^{2} + {u}_{13}^{2} + {u}_{14}^{2} + {u}_{15}^{2} + {u}_{16}^{2} )$$

$${a}_{2}^{1} = ( {u}_{12}^{2} {x}_{1} + {u}_{22}^{2} {x}_{2} + {u}_{23}^{2} {x}_{3} + {u}_{24}^{2} {x}_{4} + {u}_{25}^{2} {x}_{5} + {u}_{26}^{2} {x}_{6} ) / ( {u}_{21}^{2} + {u}_{22}^{2} + {u}_{23}^{2} + {u}_{24}^{2} + {u}_{25}^{2} + {u}_{26}^{2} )$$

Assuming that a₁¹=(0.2,0.3,0.3) and a₂¹=(0.3,0.4,0.3) after a calculation. it can be understood that, if uᵢⱼ is calculated in the Step 2, an exact value may be obtained here. To show how the algorithm works, the value of a¹ here and in following steps may be a hypothetical value.

In step 4 of the preset division algorithm: a distance value between the second clustering center set and the first clustering center set may be calculated. a¹−a⁰=∥a₁¹−a₁⁰∥²+∥a₂¹−a₂⁰∥²=(0.01+0.01)+(0.01)=0.03>ε=0.01, a stop condition may not be satisfied. A third clustering center set a₁²=(0.2,0.25,0.35), a₂²=(0.3,0.5,0.3), a²−a¹=0.015=0.015>ε=0.01 may be obtained by continuing step 2 and step 3. Continuing Step 2 and Step 3, assuming that a fourth clustering center set a₁³=(0.2,0.26,0.35), a₂³=(0.3,0.45,0.3), a³−a²=0.0026<ε=0.01 is obtained, the stop condition may be satisfied. An evaluation value J=0.00002 may be obtained by substituting the fourth clustering center set a³, and a u-value of a third affiliation matrix into a third preset expression. An affiliation may be reflected by a value of uᵢⱼ. Assuming that u₂₁>u₁₁, u₂₂>u₁₂. u₂₃<u₁₃, u₂₄>u₁₄, u₂₅<u₁₅, u₂₆>u₁₆, then x₁, x₂, x₄, x₆ may belong to a₂, x₃ and x₅ may belong to a₁, i.e., x₁, x₂, x₄, x₆ may belong to a type and a bookkeeping voucher may be generated, and x₃ and x₅ may belong to a type and another bookkeeping voucher may be generated.

In step 5 of the preset division algorithm: the first preset count c=3 may be changed, and finally J=0.00001 (c=3)<J=0.00002 (c=2) may be obtained similarly. That is, a cohesion of generating 3 bookkeeping vouchers may be better than a cohesion of generating 2 bookkeeping vouchers.

In some embodiments of the present disclosure, the original vouchers may be clustered into the first preset count of target clustering sets according to the key information (or the quantitative information) through the preset division algorithm, which not only improves the efficiency of clustering the vouchers and the similarity between the vouchers, but also reduces the labor cost.

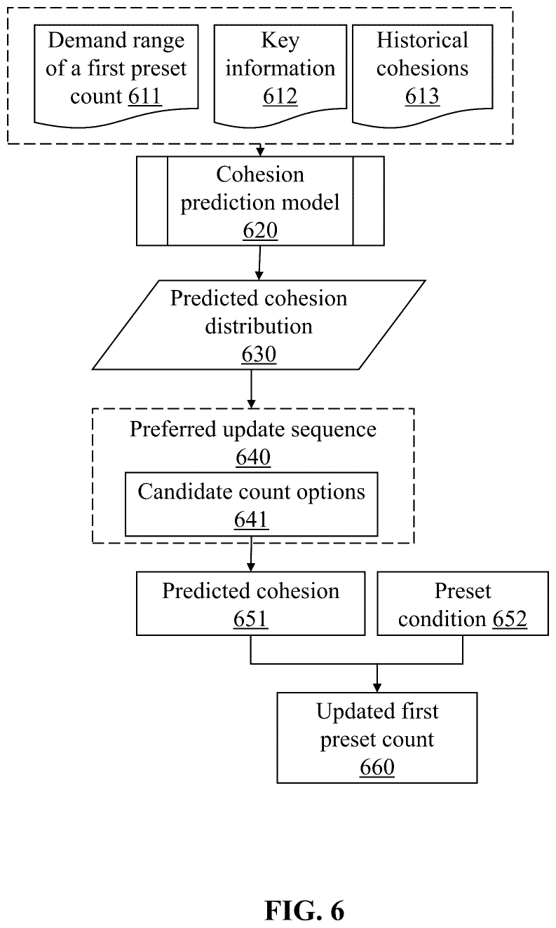

FIG. 6 is a schematic diagram illustrating an exemplary update of a first preset count according to some embodiments of the present disclosure.

Referring to FIG. 6, in some embodiments, updating the first preset count may include: determining a predicted cohesion distribution 630 through a cohesion prediction model 620 based on a demand range of the first preset count 611 and key information 612 corresponding to a second preset count of original vouchers; determining a preferred update sequence 640 based on the predicted cohesion distribution 630, the preferred update sequence including a plurality of candidate count options 641; and determining an updated first preset count 660 based on a predicted cohesion 651 corresponding to the candidate count options 641 and a preset condition 652.

The demand range of the first preset count refers to an optional count range of original vouchers.

In some embodiments, the demand range of the first preset count may be a range of a count of bookkeeping vouchers required by a user. For example, the demand range of the first preset count required by the user may stabilize a count of vouchers per month within a fluctuating range. The demand range of the first preset count may be determined based on user input, etc.

In some embodiments, the demand range of the first preset count may include at least one count option. The demand option may be used to update the first preset count.

In some embodiments, the cohesion prediction model refers to a machine learning model. For example, the cohesion prediction model may include any feasible model of a Recurrent Neural Network (RNN) model, a Deep Neural Network (DNN) model, a Convolutional Neural Network (CNN) model, or the like, or any combination thereof.

Referring to FIG. 6, in some embodiments, an input of the cohesion prediction model 620 may include the demand range of the first preset count 611 and the key information 612 corresponding to the second preset count of original vouchers. More description regarding the key information may be found in FIG. 3. In some embodiments, an output of the cohesion prediction model 620 may include the predicted cohesion distribution 630.

A cohesion may be used to indicate how closely components of a clustering result are bound to each other. A higher cohesion may indicate a better clustering result.

The predicted cohesion refers to a cohesion of a target clustering set determined by using one count option within the demand range as a first preset count based on a preset division algorithm. The predicted cohesion may be a predicted value.

In some embodiments, the predicted cohesion distribution may include a predicted cohesion corresponding to at least one count option within the demand range.

In some embodiments, the cohesion prediction model may be trained based on a plurality of second training samples with second labels to update model parameters in various ways. For example, the cohesion prediction model may be trained based on a gradient descent method.

In some embodiments, the second training samples may include a sample demand range and a sample key information set (which includes key information corresponding to second preset count of sample original vouchers). The second labels corresponding to the second training samples may include an actual cohesion distribution. In some embodiments, the second training samples may be obtained based on historical data. The second labels corresponding to the second training samples may be obtained by systematic or manual labeling. For example, a historical cohesion may be calculated based on historical clustering results of a plurality of count options within the sample demand range. For example, a processor may determine an average value of distances between individual pieces of quantitative information in the target clustering set as the historical cohesion. As another example, the processor may determine a maximum value of distances between individual pieces of quantitative information as the historical cohesion.

Referring to FIG. 6, in some embodiments, the processor may determine the preferred update sequence 640 based on the predicted cohesion distribution 630.

The preferred update sequence refers to a count option sequence for updating the first preset count. The count options that rank higher in the preferred update sequence may be prioritized for updating the first preset count.

In some embodiments, the preferred update sequence may include a plurality of candidate count options. The candidate count options may be count options that may be used to update the first preset count within the demand range. For example, the candidate count options may be count options with cohesions greater than a first cohesion threshold. The first cohesion threshold may be preset by a system or by a human being.

In some embodiments, the processor may determine the preferred update sequence based on a cohesion ranking of each count option in the predicted cohesion distribution. For example, the processor may rank a count option corresponding to a top cohesion ranking in a front position in the preferred update sequence, and rank a count option corresponding to a bottom cohesion ranking in a back position in the preferred update sequence. In some embodiments, the processor may run the cohesion prediction model prior to clustering, and determine the preferred update sequence based on an output of the model at that time.

Referring to FIG. 6, in some embodiments, the processor may determine the updated first preset count 660 based on the predicted cohesion 651 corresponding to the candidate count options 641 and the preset condition 652.

In some embodiments, the processor may sequentially update the first preset count according to the preferred update sequence, and determine an actual cohesion of the target clustering set determined according to the preset division algorithm as an actual cohesion corresponding to each candidate count option.

In some embodiments, the preset condition may be that the actual cohesion is greater than a second cohesion threshold. In some embodiments, the second cohesion threshold may be greater than or equal to the first cohesion threshold. The second cohesion threshold may be preset by the system or by the human being.

In some embodiments, the processor may determine candidate count options whose actual cohesions are greater than the second cohesion threshold as the updated first preset count.

Referring to FIG. 6, in some embodiments, the input of the cohesion prediction model 620 may also include historical cohesions 613 corresponding to a plurality of count options.

The historical cohesions refer to a cohesion of the target clustering set determined according to the preset division algorithm, which designate a count option as the first preset count. The historical cohesions may be true values. In some embodiments, the processor may determine the historical cohesions by calculating based on the target clustering set obtained from actual clustering. For example, the processor may determine an average value of the distances between individual pieces of quantitative information in the target clustering set as the historical cohesion. As another example, the processor may determine the maximum value of the distances between individual pieces of quantitative information as the historical cohesion.

In some embodiments, when the input of the cohesion prediction model also includes a plurality of historical cohesions corresponding to a plurality of count options, the processor may further update the preferred update sequence based on an output result of the cohesion prediction model during subsequent execution.

In some embodiments, the processor may re-determine a cohesion ranking of each count option based on the output result of the cohesion prediction model during the subsequent execution, i.e., the predicted cohesion distribution, and update the preferred update sequence based on a re-determined cohesion ranking.

Merely by way of example, the user's demand range for the first preset count may be within a range of 50 to 55, and after an initial run of the cohesion prediction model, the preferred update sequence may be determined to be (51, 53, 52, 55, 54) based on the model output for that run, and the first preset count may be subsequently updated according to the preferred update sequence. Further, the processor may perform clustering once on each candidate count option in the preferred update sequence, e.g., first clustering based on a first preset count of 51, then clustering based on a count option of 53 as the first preset count, and then clustering based on a count option of 52 as the first preset count. Assuming that the clustering based on a count option of 52 as the first preset count is completed, the processor may again predict a predicted cohesion distribution of remaining count options within the demand range through the cohesion prediction model. In this case, the input of the cohesion prediction model may further include a historical cohesion of the count option of 51, a historical cohesion of the count option of 53, and a historical cohesion of a count option 52. Assuming that the output result of the cohesion prediction model in this case is that a predicted cohesion of a count option of 54 is greater than a predicted cohesion of a count option of 55, then the preferred update sequence may be updated to (51, 53, 52, 54, 55). Further, the processor may sequentially cluster the count option of 54 as the first preset count, and then cluster the count option of 55 as the first preset count.

The above examples are for illustrative purposes only and are not intended to limit the scope of the present disclosure.

It should be noted that when the input of the cohesion prediction model also includes the plurality of historical cohesions corresponding to the plurality of count options, the training sample used to train the cohesion prediction model may also include sample historical cohesions accordingly.

In some embodiments of the present disclosure, a count of bookkeeping vouchers may be narrowed down by updating the first preset count through the cohesion prediction model, which greatly improves clustering efficiency. By processing the demand range of the first preset count, and the key information corresponding to the second preset count of original vouchers through the cohesion prediction model, a law may be found from a large amount of historical data using the self-learning ability of the machine learning model, thereby obtaining a correlation between the demand range of the first preset count, the key information corresponding to the second preset count of original vouchers, and the cohesion, and improving the accuracy and efficiency of determining the predicted cohesion distribution. By using the historical cohesions as the input of the cohesion prediction model, the analytical capability of the model may be further enhanced, thereby laying a foundation for a more accurate output of the predicted cohesion.

FIG. 7 is a flowchart illustrating an exemplary process for determining a target bookkeeping voucher according to some embodiments of the present disclosure. In some embodiments, a process 700 may be performed by a processor or the system 200 for generating the voucher. For example, the process 700 may be stored in the storage device 130 in the form of programs or instructions, and the process 700 may be implemented when the processor or the system 200 for generating the voucher executes the instructions. The schematic diagram illustrating an operation of the process 700 presented below is illustrative. In some embodiments, the process may be completed using one or more additional operations not described and/or one or more operations not discussed. In addition, an order of the operation of the process 400 illustrated in FIG. 7 and described below is not limiting. As shown in FIG. 7, the process 700 may include following operations.

In some embodiments, the processor may determine, with respect to one original voucher set of at least one original voucher set, a target bookkeeping voucher corresponding to each original voucher set by 710-740.

In 710, at least one temporary bookkeeping voucher corresponding to the at least one original voucher set may be generated based on key information.

The temporary bookkeeping voucher refers to a bookkeeping voucher to be recognized as a target bookkeeping voucher. Each temporary bookkeeping voucher may correspond to an original voucher set.

In some embodiments, each temporary bookkeeping voucher may include at least one temporary sub-bookkeeping voucher of a second voucher type. For example, when an original voucher obtained in 310 is made of a plurality of first voucher types, then a plurality of temporary sub-bookkeeping vouchers of second voucher types may be generated, thereby obtaining a temporary bookkeeping voucher including the plurality of temporary sub-bookkeeping vouchers of the second voucher types. When the original voucher obtained in 310 is made of one first voucher type, then one temporary sub-bookkeeping voucher of the second voucher type may be generated, thereby obtaining a temporary bookkeeping voucher including one temporary sub-bookkeeping voucher of the second voucher type.

In some embodiments, the processor may generate the at least one temporary bookkeeping voucher corresponding to the at least one original voucher set in multiple ways. For example, for key information corresponding to each original voucher in the original voucher set, the processor may, based on the key information, match the key information with historical key information from a historical database whose similarity to the key information is greater than a similarity threshold, and determine at least one historical bookkeeping voucher corresponding to the historical key information as the temporary bookkeeping voucher corresponding to the original voucher. When there is at least one piece of historical key information, at least one temporary bookkeeping voucher may be determined. The similarity between the key information and the historical key information may be determined based on a vector distance, and the similarity threshold may be preset by the system or by the human being.

In some embodiments, the processor may obtain a plurality of pieces of entry information by converting the key information of the original voucher through a preset conversion rule based on a first voucher type corresponding to the at least one original voucher set; and determine the at least one temporary bookkeeping voucher based on the plurality of pieces of entry information.

More descriptions regarding the first voucher type and the entry information may be found in FIG. 3 and related descriptions thereof.

The preset conversion rule refers to a process or procedure for converting the key information into the entry information. The preset conversion rule may be composed of an existing algorithm or a customized algorithm.

In some embodiments, the preset conversion rule may include at least one conversion relationship for converting the original voucher into at least one type (i.e., the second voucher type) of sub-bookkeeping voucher. For example, the original voucher may be converted into entry information corresponding to at least one type of bookkeeping voucher, such as a payment voucher, a receipt voucher, a transfer voucher, a generic voucher, or the like, through the at least one conversion relationship included in the preset conversion rule.

In some embodiments, the preset conversion rule may be related to the first voucher type of the original voucher. The preset conversion rules corresponding to different first voucher types may be different. More descriptions regarding the preset conversion rule may be found in the previous descriptions regarding the conversion relationship.

In some embodiments, for each original voucher set in the at least original voucher set, the processor may determine a corresponding preset conversion rule based on the first voucher type of the original voucher set, and obtain a plurality of pieces of entry information by converting key information of each original voucher in the original voucher set based on the corresponding preset conversion rule. For example, the processor may determine the preset conversion rule corresponding to the first voucher type by querying a preset relationship table based on the first voucher type. In some embodiments, the preset relationship table may include corresponding relationships between different first voucher types and different preset conversion rules. The preset relationship table may be pre-set based on historical data and/or priori knowledge.

In some embodiments, the processor may determine at least one recognition result based on the at least one original voucher set; and obtain the plurality of pieces of entry information by converting the at least one recognition result through the preset conversion rule based on the first voucher type.

The recognition result refers to a result of recognizing the key information of the original voucher. In some embodiments, the recognition result may be a text recognition result.

In some embodiments, for each original voucher in the original voucher set, the processor may obtain at least one recognition result corresponding to at least one piece of item information in the key information by performing at least one recognition process on the original voucher through the preset recognition algorithm. Each piece of item information may correspond to the at least one recognition result. More descriptions regarding the item information may be found in FIG. 3 and related descriptions thereof.

In some embodiments, the processor may obtain the plurality of pieces of entry information by converting the at least one recognition result through the preset conversion rule. Converting the recognition result through the preset conversion rule may be performed in ac same manner as converting the key information through the preset conversion rule, which is not repeated here.

In some embodiments, the temporary bookkeeping voucher may include at least one temporary sub-bookkeeping voucher. The second voucher types of different temporary sub-bookkeeping vouchers in the temporary bookkeeping voucher may be different.

In some embodiments, the processor may generate at least one temporary bookkeeping voucher based on the plurality of pieces of entry information in multiple ways. For example, the processor may obtain at least one entry information combination by randomly combining the plurality of pieces of entry information. Each of the at least one entry information combination may include at least one entry information sub-combination. Each of the at least one entry information sub-combination may include at least one piece of entry information. The at least one piece of entry information included in each of the at least one entry information sub-combination may be used to fill one temporary sub-bookkeeping voucher. Correspondingly, each combination of entry information may be used to fill a temporary bookkeeping voucher. Further, the processor may generate the at least one temporary bookkeeping voucher based on the at least one entry information combination.

In some embodiments of the present disclosure, generating the at least one temporary bookkeeping voucher may facilitate subsequent determination of a final target bookkeeping voucher, thereby further improving the accuracy of generating the target bookkeeping voucher.

In 720, a first accuracy corresponding degree to the temporary sub-bookkeeping voucher may be determined based on the key information and the at least one piece of entry information corresponding to the temporary sub-bookkeeping voucher.

The first accuracy degree refers to a matching degree between a temporary sub-bookkeeping voucher in a temporary bookkeeping voucher and an original voucher corresponding to the temporary sub-bookkeeping voucher. The higher the first accuracy degree, the better the matching degree between the temporary sub-bookkeeping voucher and the original voucher corresponding to the temporary sub-bookkeeping voucher.

In some embodiments, the processor may determine the first accuracy degree in various ways, e.g., a mathematical algorithm, etc.

In some embodiments, for each temporary sub-bookkeeping voucher included in the temporary bookkeeping voucher, the processor may determine at least one matching value between the key information and the at least one piece of entry information corresponding to the temporary sub-bookkeeping voucher; and obtain the first accuracy degree of the temporary sub-bookkeeping voucher by weighting the at least one matching value.

The matching value refers to a matching degree between item information in the key information of the original voucher and entry information corresponding to the temporary sub-bookkeeping voucher.

In some embodiments, the processor may perform one-to-one comparison between the item information of the original voucher and the entry information of the temporary sub-bookkeeping voucher, and calculate a matching value between the item information and the entry information corresponding to the item information. For example, the processor may calculate a matching value between a summary of an entry and an accounting section and an invoice name, calculate a matching value between an accounting item of the entry and a name of a counterparty of the invoice, and calculate a matching value between an amount of the invoice and an amount of the entry. In some embodiments, the processor may calculate the matching value between the item information and the entry information corresponding to the item information through a text similarity algorithm, etc.

In some embodiments, the processor may perform weighted summation on the matching value between the at least one piece of item information in the key information and the entry information corresponding to the item information, and use a weighted result as the first accuracy degree of the temporary sub-bookkeeping voucher. A weighting weight (hereinafter referred to as a first weight) corresponding to the at least one matching value may be preset by the system or by the human being.

In some embodiments, the first weight corresponding to the at least one matching value may be related to the entry information corresponding to the temporary sub-bookkeeping voucher. For example, a technician may pre-set first weights corresponding to different entry information, and determine the first weight corresponding to a matching degree between the entry information and the key information corresponding to the entry information based on a type of the entry information.

In some embodiments, the processor may determine target entry information and a matching value corresponding to the target entry information; determine a standard matching value by normalizing the matching value corresponding to the target entry information; and determine the first accuracy of the temporary bookkeeping voucher based on the standard matching value and the at least one matching value.

In some embodiments, the target entry information may be entry information with a matching value higher than a matching threshold. In some embodiments, the target entry information may be entry information with a highest matching value.

In some embodiments, the processor may determine at least one piece of target entry information from each temporary sub-bookkeeping voucher. In some embodiments, the processor may determine the at least one piece of target entry information from the at least one temporary bookkeeping voucher.

The standard matching value refers to standard data obtained by normalizing the matching value corresponding to the target entry information.

In some embodiments, the processor may determine the at least one piece of target entry information as described previously. In some embodiments, the processor may determine the standard matching value by normalizing the matching value of the at least one piece of target entry information.

In some embodiments, the processor may sum the matching value of the at least one piece of target entry information, and determine a ratio of a summed result to a total count of pieces of target entry information as the standard matching value.

In some embodiments, the total count of pieces of target entry information may be a count of pieces of target entry information in one temporary sub-bookkeeping voucher. Correspondingly, the at least one piece of target entry information for which the sum of the matching value is performed may be target entry information in one temporary sub-bookkeeping voucher. In some embodiments, the total count of pieces of target entry information may be a count of pieces of target entry information in the at least one temporary bookkeeping voucher. Correspondingly, the at least one piece of target entry information for which the sum of the matching value is performed may be the target entry information in the at least one temporary bookkeeping voucher.

In some embodiments, for each temporary sub-bookkeeping voucher, the processor may determine at least one filtered matching value from the at least one matching value based on the standard matching value, and obtain the first accuracy of the temporary sub-bookkeeping voucher by weighting the at least one filtered matching value.

The filtered matching value refers to a matching value that is filtered from the at least one matching value. The filtered matching value may be determined by the standard matching value. For example, the processor may determine a matching value greater than or equal to the standard matching value as the filtered matching value.

In some embodiments, for each temporary sub-bookkeeping voucher, the processor may determine the first accuracy of the temporary sub-bookkeeping voucher by performing weighted summation on the at least one filtered matching value.

In some embodiments of the present disclosure, a same standard matching value of individual pieces of entry information of the temporary sub-bookkeeping voucher may be determined through a normalization process, which facilitates comparison of the recognition accuracy of the entry information of each temporary sub-bookkeeping voucher based on the respective standard matching value. The first accuracy degree may be determined by determining the at least one filtered matching value, thereby reducing redundant data, optimizing calculations, and greatly reducing the amount of work.

In some embodiments of the present disclosure, the accuracy degree of the temporary sub-bookkeeping voucher may be accurately and efficiently determined by determining the matching value between individual pieces of item information and the entry information corresponding to the item information; and determining a first accuracy degree set corresponding to the at least one temporary sub-bookkeeping voucher combination by calculating the standard matching value, thereby making the first accuracy set more accurate.

In 730, a second accuracy degree corresponding to the temporary bookkeeping voucher may be determined based on the first accuracy degree corresponding to the at least one temporary sub-bookkeeping voucher.

The second accuracy degree refers to an accuracy degree of the temporary bookkeeping voucher. The second accuracy degree may be used to measure a matching degree of the temporary bookkeeping voucher with the original voucher.

In some embodiments, the second accuracy degree may be determined in various ways. For example, the processor may determine a statistical value (e.g., a median value, an average value, a mode, etc.) in the first accuracy degree corresponding to the at least one temporary sub-bookkeeping voucher as the second accuracy degree of the temporary bookkeeping voucher.

In some embodiments, for each temporary bookkeeping voucher, the processor may obtain the second accuracy degree of the temporary bookkeeping voucher by weighting the first accuracy degree of the at least one temporary sub-bookkeeping voucher based on a second voucher type of the at least one temporary sub-bookkeeping voucher included in the temporary bookkeeping voucher.

In some embodiments, weights (hereinafter referred to as a second weight) corresponding to the first accuracy degrees of temporary sub-bookkeeping vouchers of different second voucher types may be different. The second weight may be preset by the system or by the human being.

In some embodiments of the present disclosure, the second weight may be determined through the second voucher type, and the second accuracy degree may be calculated through weighting, so that marketing of different second voucher types may be considered while determining the accuracy of the temporary bookkeeping voucher, thereby improving the effectiveness of the second accuracy degree.

In some embodiments, the processor may determine a generation reliability of the temporary sub-bookkeeping voucher based on a selected data combination of the temporary sub-bookkeeping voucher; and determine the second accuracy degree corresponding to the temporary sub-bookkeeping voucher based on the generation reliability and the first accuracy degree.

Selected data refers to a specific recognition result selected from a plurality of recognition results corresponding to the item information. The selected data combination refers to a specific recognition result corresponding to the at least one piece of item information included in the original voucher. The selected data combination may be determined by the system or the human being.

The generation reliability refers to a reliability degree determined by a confidence level of a data source from which the temporary sub-bookkeeping voucher is generated. The higher the generation reliability, the more credible the data source of the temporary sub-bookkeeping voucher.

In some embodiments, the processor may determine the generation reliability of the temporary sub-bookkeeping voucher by querying a preset comparison table based on the selected data combination of the temporary sub-bookkeeping voucher. In some embodiments, the preset comparison table may include corresponding relationships between different selected data combinations and different generation reliabilities. In some embodiments, the preset comparison table may be determined based on historical data or priori knowledge. For example, generation reliabilities corresponding to different selected data combinations may be determined based on a result of manual calibration in the historical data.

In some embodiments, the processor may determine a recognition confidence level and a data confidence level of the selected data combination, and determine the generation reliability of the temporary sub-bookkeeping voucher based on the recognition confidence level and the data confidence level.

The recognition confidence level refers to a confidence level of a recognition result corresponding to the item information. The higher the recognition confidence level, the closer the recognition result corresponding to the item information is to actual item information. In some embodiments, the recognition confidence level may be determined based on a similarity of the actual item information to the recognition result. The higher the similarity, the higher the recognition confidence level. For example, the processor may determine a reciprocal of a vector distance between the actual item information and the recognition result as the similarity of the actual item information to the recognition result.

The data confidence level refers to a truth degree of filling content in the item information. The higher the data confidence level, the more real the filling content in the item information, and the lower the possibility of falsification.

In some embodiments, the processor may determine the data confidence level of the selected data combination through a confidence level assessment model. In some embodiments, the confidence level assessment model may be a machine learning model, e.g., a deep learning neural network, etc.

In some embodiments, an input of the confidence level assessment model may be the selected data combination, and an output of the confidence level assessment model may be the data confidence level of the selected data combination.

In some embodiments, the confidence level assessment model may be trained by various manners based on a plurality of first training samples with first labels. For example, the confidence level assessment model may be trained based on a gradient descent method. Merely by way of example, the plurality of first training samples with the first labels may be input into an initial confidence level assessment model, a loss function may be constructed from the first labels and a result of the initial confidence level assessment model, and parameters of the initial confidence level assessment model may be iteratively updated based on the loss function. Model training may be completed when the loss function of the initial confidence level assessment model satisfies a preset iteration condition, and a trained confidence level assessment model may be obtained. The preset iteration condition may be that the loss function converges, a count of iterations reaches a threshold, or the like.

In some embodiments, the first training samples may include a sample recognition result of a sample original voucher. The first labels corresponding to the first training samples may include a data confidence level of the sample recognition result.

In some embodiments, the first training samples may be obtained based on historical data. The first labels corresponding to the first training samples may be obtained by manual labeling. For example, real item information of historical original vouchers may be used as the first training samples, and the first labels of the first training samples may be labeled as 1. As another example, the real item information of the historical original vouchers may be adapted as the first training samples, and the first labels of the first training samples may be labeled as 0. Adaptation may include adding a typo, adjusting an original amount of original data, or the like.

In some embodiments, historical recognition results of the sample original voucher may also be used as the first training samples, and the first labels may be marked by the human being or the system based on differences between the historical recognition results and the real item information. For example, the larger the differences, the closer the first labels are to 0; and the smaller the differences, the closer the first labels are to 1.

In some embodiments, the processor may determine the second accuracy degree corresponding to the temporary bookkeeping voucher in multiple ways based on the generation reliability and the first accuracy degree corresponding to the at least one temporary sub-bookkeeping voucher included in the temporary bookkeeping voucher. For example, the processor may obtain a first weighed result by performing weighted summation on the generation reliabilities corresponding to the at least one temporary sub-bookkeeping voucher, obtain a second weighted result by performing weighted summation on the first accuracy degrees corresponding to the at least one temporary sub-bookkeeping voucher, and determine a smaller value of the first weighted result and the second weighted result as the second accuracy degree of the temporary bookkeeping voucher. As another example, the processor may determine an average value of the first weighted result and the second weighted result as the second accuracy degree of the temporary bookkeeping voucher. A weighting weight of the weighted summation may be preset by the system or by the human being.

In some embodiments of the present disclosure, the second accuracy degree of the temporary bookkeeping voucher may be comprehensively determined based on the generation reliability and the first accuracy degree of the temporary sub-bookkeeping voucher, and the impact of the generation reliability on determining the second accuracy degree of the temporary bookkeeping voucher may be fully considered, thereby avoiding the impact of the falsification or inaccurate recognition of the original voucher such as an invoice on determining the temporary bookkeeping voucher. Meanwhile, by processing the selected data combination through the confidence level assessment model, a law may be found from a large number of historical selected data combinations using the self-learning capability of the machine learning model, thereby obtaining a correlation between the selected data combination and the data confidence level, and improving the accuracy and efficiency of the data confidence level.

In 740, a target bookkeeping voucher may be determined based on the second accuracy degree corresponding to the at least one temporary bookkeeping voucher.

In some embodiments, the processor may determine the target bookkeeping voucher based on a second accuracy degree of each temporary bookkeeping voucher in the at least one temporary bookkeeping voucher in multiple ways. For example, the processor may determine a temporary bookkeeping voucher with a highest second accuracy degree as the target bookkeeping voucher. As another example, the processor may determine a temporary bookkeeping voucher with a second accuracy degree reaching an accuracy degree threshold as the target bookkeeping voucher.

In some embodiments of the present disclosure, a method of determining the target bookkeeping voucher based on key information and through a preset generation rule may be efficient and accurate, and may efficiently and accurately obtain the target bookkeeping voucher, having a greater confidence level compared to artificial determination. The second accuracy degrees of the plurality of temporary bookkeeping vouchers may be calculated, and the temporary bookkeeping voucher with the highest second accuracy degree may be determined as the final target bookkeeping voucher, thereby increasing the accuracy of the target bookkeeping voucher, realizing a self-correcting function of the original voucher according to the final target bookkeeping voucher, and avoiding the problem of incorrect entry of information.

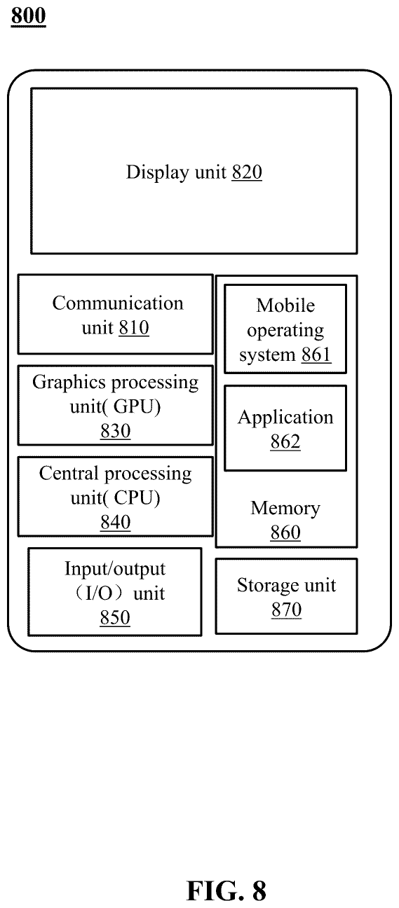

FIG. 8 is a schematic diagram illustrating exemplary hardware and/or software of an exemplary mobile device according to some embodiments of the present disclosure.

As shown in FIG. 8, a mobile device 800 may include a communication unit 810, a display unit 820, a graphics processing unit (GPU) 830, a central processing unit (CPU) 840, an input/output (I/O) unit 850, a memory 860, a storage unit 870, or the like. In some embodiments, the mobile device 800 may also include any other suitable components, including, but not limited to, a system bus or a controller (not shown in the figure). In some embodiments, a mobile operating system 861 (e.g., iOS, Android, Windows Phone, etc.) and an application 862 may be loaded from the storage unit 870 into the memory 860 for execution by the central processing unit 840. The application 862 may include a browser or an application for receiving characters, images, audio, or other related information from the system 200 for generating the voucher. User interaction of information stream may be realized through the input/output (I/O) unit 850 and provided to the server 110 and/or other components of the system 200 for generating the voucher via the network 120.

In order to implement various modules, units, and functions thereof described in the present disclosure, a computing device or a mobile device may be used as a hardware platform for one or more of the components described herein. Hardware components, operating systems, and programming languages of these computing or mobile devices may be inherently conventional and applied to the systems described in the present disclosure by those skilled in the art familiar with these techniques. Computers with user interface elements may be configured to implement personal computers (PCs) or other types of workstations or terminal devices, and, if appropriately programmed, the computers may also act as servers.

FIG. 9 is a schematic diagram illustrating exemplary hardware and/or software of an exemplary computing device according to some embodiments of the present disclosure. In some embodiments, functions of the server 110 and the user terminal 140 may be implemented on a computing device 900. As shown in FIG. 9, the computing device 900 may include a bus 910, a processor 920, a read-only memory (ROM) 930, a random access memory (RAM) 940, a communication port 950, an input/output 960, and a hard disk 970.

The processor 920 may execute computational instructions (program codes) and perform functions of the system 200 for generating the voucher described in the present disclosure. The computational instructions may include programs, objects, components, data structures, procedures, modules, functions (which are specific functions described in the present disclosure), or the like. For example, the processor 920 may be configured to obtain an original voucher by executing at least some of the computational instructions. As another example, the processor 920 may be configured to extract key information of the original voucher by executing at least some of the computational instructions. As another example, the processor 920 may be configured to generate a target bookkeeping voucher corresponding to the original voucher based on the key information through a preset generation rule by executing at least some of the computational instructions.

In some embodiments, the processor 920 may include one or more processing engines (e.g., a single-chip processing engine or a multi-chip processing engine). Merely by way of example, the processor 920 may include a central processing unit (CPU), an application-specific integrated circuit (ASIC), an application-specific instruction processor (ASIP), a graphics processor (GPU), a physical processor (PPU), a digital signal processor (DSP), a field programmable gate array (FPGA), a programmable logic circuit (PLD), a controller, a microcontroller unit, a reduced instruction set computer (RISC), a microprocessor, or the like, or any combination thereof. For illustrative purposes only, the computing device 900 in FIG. 9 describes only one processor. It should be noted that the computing device 900 in the present disclosure may also include a plurality of processors.

A memory (e.g., a read-only memory (ROM) 930, a random memory (RAM) 940, a hard disk 970, etc.) of the computing device 900 may store data/information obtained from any other components of the system 200 for generating the voucher. Exemplary ROMs may include a mask ROM (MROM), a programmable ROM (PROM), an erasable programmable ROM (EPROM), an electrically erasable programmable ROM (EEPROM), a compact disc ROM (CD-ROM), a digital universal disk ROM, or the like. Exemplary RAMs may include a dynamic RAM (DRAM), a double-rate synchronous dynamic RAM (DDR SDRAM), a static RAM (SRAM), a thyristor RAM (T-RAM), a zero-capacitance (Z-RAM), or the like.

The input/output 960 may be configured to input or output signals, data, or information. In some embodiments, the input/output 960 may include an input device and an output device. Exemplary input devices may include a keyboard, a mouse, a touch screen, a microphone, or the like, or any combination thereof. Exemplary output devices may include a display device, a loudspeaker, a printer, a projector, or the like, or any combination thereof. Exemplary display devices may include a liquid crystal display (LCD), a light-emitting diode (LED)-based display, a flat-panel display, a curved display, a television device, cathode ray tubes (CRTs), or the like, or any combination thereof.

The communication port 950 may be connected to a network for data communication. The connection may be a wired connection, a wireless connection, or a combination thereof. The wired connection may include a cable, a fiber optic cable, a telephone line, or the like, or any combination thereof. The wireless connection may include Bluetooth, Wi-Fi, WiMAX, WLAN, ZigBee, a mobile network (e.g., 3G, 4G, 5G, etc.), or the like, or any combination thereof. In some embodiments, the communication port 950 may be a standardized port, e.g., RS232, RS485, etc. In some embodiments, the communication port 950 may be a specially designed port.

The basic concept has been described above. Obviously, for those skilled in the art, the above detailed disclosure is only an example, and does not constitute a limitation to the present disclosure. Although not expressly stated here, those skilled in the art may make various modifications, improvements and corrections to the present disclosure. Such modifications, improvements and corrections are suggested in this disclosure, so such modifications, improvements and corrections still belong to the spirit and scope of the exemplary embodiments of the present disclosure.

Meanwhile, the present disclosure uses specific words to describe the embodiments of the present disclosure. For example, “one embodiment”, “an embodiment”, and/or “some embodiments” refer to a certain feature, structure or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures or characteristics in one or more embodiments of the present disclosure may be properly combined.

In addition, unless clearly stated in the claims, the sequence of processing elements and sequences described in the present disclosure, the use of counts and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in this disclosure and help the understanding of one or more embodiments of the invention, in the foregoing description of the embodiments of the present disclosure, sometimes multiple features are combined into one embodiment, drawings or descriptions thereof. This method of disclosure does not, however, imply that the subject matter of the disclosure requires more features than are recited in the claims. Rather, claimed subject matter may lie in less than all features of a single foregoing disclosed embodiment.

In some embodiments, counts describing the quantity of components and attributes are used. It should be understood that such counts used in the description of the embodiments use the modifiers “about”, “approximately” or “substantially” in some examples. Unless otherwise stated, “about”, “approximately” or “substantially” indicates that the stated figure allows for a variation of ±20%. Accordingly, in some embodiments, the numerical parameters used in the disclosure and claims are approximations that can vary depending upon the desired characteristics of individual embodiments. In some embodiments, numerical parameters should consider the specified significant digits and adopt the general digit retention method. Although the numerical ranges and parameters used in some embodiments of the present disclosure to confirm the breadth of the range are approximations, in specific embodiments, such numerical values are set as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for generating a voucher, implemented by a processor, comprising:
obtaining at least one original voucher;
extracting key information of the original voucher;
dividing the original voucher into at least one original voucher set based on the key information, the at least one original voucher set including at least one original voucher of a first voucher type; and
generating at least one target bookkeeping voucher corresponding to the at least one original voucher set.

2. The method of claim 1, wherein the extracting key information of the original voucher includes:
determining the key information by processing the original voucher based on a preset recognition algorithm.

3. The method of claim 1, wherein the preset recognition algorithm includes at least one of optical character recognition (OCR), regular parsing, or field mapping.

4. The method of claim 1, wherein the dividing the original voucher into at least one original voucher set based on the key information includes:
determining a quantitative information matrix by performing a quantitative processing on the key information; and
determining at least one target clustering set by performing a clustering process on the quantitative information matrix based on a preset division algorithm, and determining the at least one original voucher set; a count of the at least one target clustering set being related to a first preset count of the at least one target bookkeeping voucher.

5. The method of claim 4, wherein the key information includes a plurality of pieces of item information of the original voucher; and the determining a quantitative information matrix by performing a quantitative processing on the key information includes:
recognizing a count of the pieces of item information of the original voucher based on the key information;
generating quantitative information of the original voucher by quantifying the item information; and
forming the quantitative information matrix based on the count of the pieces of item information and quantitative information of each original voucher in the at least one original voucher.

6. The method of claim 4, wherein the preset division algorithm includes:
setting a fuzzy indication value based on the quantitative information matrix, and determining a first clustering matrix, the first clustering matrix including a first preset count of first eigenvalue sets; and
determining the at least one target clustering set by performing an iterative update on the first clustering matrix;
wherein the iterative update includes:
determining a first affiliation matrix of the quantitative information matrix with respect to a first clustering center set by calculating an affiliation correlation of each piece of quantitative information with each first clustering center of the first clustering center set through a first preset expression;
calculating a second clustering center set based on the first affiliation matrix through a second preset expression, the second clustering center set including a second preset count of second clustering centers;
calculating a distance value between the second clustering center set and the first clustering center set based on a distance expression, and in response to a determination that the distance value is less than a preset distance threshold, stopping the iterative update; and
determining the at least one target clustering set based on a second clustering center set of a last iteration, and determining an original voucher corresponding to quantitative information divided to each of the at least one target clustering set based on a first affiliation matrix of the last iteration, and determining the at least one original voucher set.

7. The method of claim 6, further comprising:
calculating a first evaluation value corresponding to the at least one target clustering set based on a third preset expression;
updating the first preset count, and obtaining a second evaluation value corresponding to an updated first preset count of target clustering sets by performing the clustering process on the quantitative information matrix based on the preset division algorithm again; and
in response to a determination that the second evaluation value is less than the first evaluation value, determining the at least one target clustering set based on a second clustering center set corresponding to the updated first preset count, and determining the original voucher corresponding to the quantitative information divided to each of the at least one target clustering set, and obtaining the at least one original voucher set.

8. The method of claim 6, wherein the iterative update further includes:
in response to a determination that the distance value is not less than the preset distance threshold, using a second clustering center set of a current iteration as a first clustering center set of a next iteration, and determining a first affiliation matrix and a second clustering center set of the next iteration.

9. The method of claim 6, wherein the generating the at least one target bookkeeping voucher corresponding to the at least one original voucher set based on the key information includes:
generating a first preset count of target bookkeeping vouchers based on a clustering center of the each of the at least one target clustering set and the original voucher corresponding to the quantitative information divided to the each of the at least one target clustering set.

10. The method of claim 7, wherein the updating the first preset count includes:
determining a predicted cohesion distribution based on a demand range of the first preset count, and key information corresponding to a second preset count of original vouchers through a cohesion prediction model, the cohesion prediction model being a machine learning model, and the predicted cohesion distribution including a predicted cohesion of at least one count option within the demand range;
determining a preferred update sequence based on the predicted cohesion distribution, the preferred update sequence including a plurality of candidate count options; and
determining the updated first preset count based on predicted cohesion distributions corresponding to the plurality of candidate count options and a preset condition.

11. The method of claim 1, wherein the generating at least one target bookkeeping voucher corresponding to the at least one original voucher set includes:
for each of the at least one original voucher set,
generating at least one temporary bookkeeping voucher corresponding to the original voucher set based on the key information, the temporary bookkeeping voucher including at least one temporary sub-bookkeeping voucher of a second voucher type;
determining a first accuracy degree corresponding to the temporary sub-bookkeeping voucher based on the key information and at least one piece of entry information corresponding to the temporary sub-bookkeeping voucher;
determining a second accuracy degree corresponding to the temporary bookkeeping voucher based on the first accuracy degree corresponding to the temporary sub-bookkeeping voucher; and
determining the target bookkeeping voucher based on the second accuracy degree corresponding to the temporary bookkeeping voucher.

12. The method of claim 11, wherein the generating at least one temporary bookkeeping voucher corresponding to the at least one original voucher set based on the key information includes:
converting the key information of the original voucher through a preset conversion rule based on the first voucher type corresponding to the at least one original voucher set, and obtaining a plurality of pieces of entry information; and
generating the at least one temporary bookkeeping voucher based on the plurality of pieces of entry information.

13. The method of claim 11, wherein the determining a first accuracy degree corresponding to the temporary sub-bookkeeping voucher based on the key information and at least one piece of entry information corresponding to the temporary sub-bookkeeping voucher includes:
determining at least one matching value between the key information and the at least one piece of entry information corresponding to the temporary sub-bookkeeping voucher;
obtaining the first accuracy degree corresponding to the temporary sub-bookkeeping voucher by weighting the at least one matching value.

14. The method of claim 13, wherein the determining a first accuracy degree corresponding to the temporary sub-bookkeeping voucher based on the key information and at least one piece of entry information corresponding to the temporary sub-bookkeeping voucher includes:
determining target entry information and a matching value corresponding to the target entry information;
determining a standard matching value by normalizing the matching value corresponding to the target entry information; and
determining the first accuracy degree corresponding to the temporary sub-bookkeeping voucher based on the standard matching value and the at least one matching value.

15. The method of claim 12, wherein the converting the key information of the original voucher through a preset conversion rule based on the first voucher type corresponding to the at least one original voucher set, and obtaining a plurality of pieces of entry information includes:
determining at least one recognition result based on the at least one original voucher set; and
obtaining the plurality of pieces of entry information by converting the at least one recognition result through the preset conversion rule based on the first voucher type.

16. The method of claim 12, wherein the determining a second accuracy degree corresponding to the temporary bookkeeping voucher based on the first accuracy degree corresponding to the temporary sub-bookkeeping voucher includes:
obtaining the second accuracy degree corresponding to the temporary bookkeeping voucher by weighting the first accuracy degree corresponding to the temporary sub-bookkeeping voucher based on a second voucher type of the temporary sub-bookkeeping voucher.

17. The method of claim 12, wherein determining the second accuracy degree corresponding to the temporary bookkeeping voucher based on a first accuracy degree set includes:
determining a generation reliability of the temporary sub-bookkeeping voucher based on a combination of selected data of the temporary sub-bookkeeping voucher; and
determining the second accuracy degree corresponding to the temporary bookkeeping voucher based on the generation reliability and the first accuracy degree.

18. The method of claim 17, wherein a manner of determining the generation reliability includes:
determining a recognition confidence level and a data confidence level of the combination of selected data; and
determining the generation reliability of the temporary sub-bookkeeping voucher based on the recognition confidence level and the data confidence level.

19. A system for generating a voucher, comprising at least one processor and at least one storage; wherein
the at least one storage is configured to store computer instructions; and
the at least one processor is configured to execute at least some of the computer instructions to:
obtain at least one original voucher;
extract key information of the at least one original voucher; and
generate a target bookkeeping voucher corresponding to the at least one original voucher through a preset generation rule based on the key information.

20. A non-transitory computer-readable storage medium, comprising computer instructions that, when read by a computer, direct the computer to perform the method for generating the voucher of claim 1.
